(19) United States
(12) Patent Application Publication
(10) Pub. No.: US 2013/0070051 A1
(43) Pub. Date: Mar. 21, 2013

(54) VIDEO ENCODING METHOD AND APPARATUS FOR ENCODING VIDEO DATA INPUTS INCLUDING AT LEAST ONE THREE-DIMENSIONAL ANAGLYPH VIDEO, AND RELATED VIDEO DECODING METHOD AND APPARATUS

(71) Applicants: Cheng-Tsai Ho, Taichung City (TW); Ding-Yun Chen, Taipei City (TW); Chi-Cheng Ju, Hsinchu City (TW)

(72) Inventors: Cheng-Tsai Ho, Taichung City (TW); Ding-Yun Chen, Taipei City (TW); Chi-Cheng Ju, Hsinchu City (TW)

(21) Appl. No.: 13/483,066

(22) Filed: May 30, 2012

Related U.S. Application Data
(60) Provisional application No. 61/536,977, filed on Sep. 20, 2011.

(51) Int. Cl. H04N 13/00

(52) U.S. Cl. 348/43; 348/E13.062

(57) ABSTRACT

A video encoding method includes: receiving a plurality of video data inputs corresponding to a plurality of video display formats, respectively, wherein the video display formats include a first three-dimensional (3D) anaglyph video; generating a combined video data by combining video contents derived from the video data inputs; and generating an encoded video data by encoding the combined video data. A video decoding method includes: receiving an encoded video data having encoded video contents of a plurality of video data inputs combined therein, wherein the video data inputs correspond to a plurality of video display formats, respectively, and the video display formats include a first three-dimensional (3D) anaglyph video; and generating a decoded video data by decoding the encoded video data.

### CROSS REFERENCE TO RELATED APPLICATIONS

This application claims the benefit of U.S. provisional application No. 61/536,977, filed on Sep. 20, 2011 and incorporated herein by reference.

### BACKGROUND

The disclosed embodiments of the present invention relate to video encoding/decoding, and more particularly, to video encoding method and apparatus for encoding a plurality of video data inputs including at least one three-dimensional anaglyph video, and related video decoding method and apparatus.

With the development of science and technology, users are pursing stereoscopic and more real image displays rather than high quality images. There are two techniques of present stereoscopic image display. One is to use a video output apparatus which collaborates with glasses (such as anaglyph glasses), while the other is to directly use a video output apparatus without any accompanying glasses. No matter which technique is utilized, the main theory of stereo image display is to make the left eye and the right eye see different images, thus the brain will regard the different images seen from two eyes as stereo images.

Regarding a pair of anaglyph glasses used by the user, it has two lenses with chromatically opposite colors (i.e., complementary colors), such as read and cyan, and allows the user to perceive three-dimensional (3D) effect by viewing a 3D anaglyph video composed of anaglyph images. Each of the anaglyph images is made up of two color layers, superimposed, but offset with respect to each other to produce a depth effect. When the user wears the anaglyph glasses to view each anaglyph image, the left eye would view one filtered colored image, and the right eye would view the other filtered colored image that is slightly different from the filtered colored image viewed by the left eye.

The 3D anaglyph technique has seen a recent resurgence due to the presentation of images and video on the Internet (e.g., YouTube, Google map street view, etc.), Blu-ray discs, digital versatile discs, and even in print. As mentioned above, the 3D anaglyph video may be created by using any combination of complementary colors. When the color pair of the 3D anaglyph video does not match the color pair employed by the anaglyph glasses, the user fails to have the wanted 3D experience. Besides, the user may feel uncomfortable when viewing the 3D anaglyph video for a long time, and may want to view the video content displayed in a two-dimensional (2D) manner. Further, the user may desire to view the video content presented by the 3D anaglyph video in a preferred depth setting. In general, disparity is referenced as coordinate differences of the point between a right-eye image and a left-eye image, and is usually measured in pixels. Thus, 3D anaglyph video playback with different disparity settings would result in different depth perception. Thus, there is a need for an encoding/decoding scheme which allows the video playback to switch between different video display formats, such as a two-dimensional (2D) video and a 3D anaglyph video, a 3D anaglyph video with a first color pair and a 3D anaglyph video with a second color pair, or a 3D anaglyph video with a first disparity setting and a 3D anaglyph video with a second disparity setting.

### SUMMARY

In accordance with exemplary embodiments of the present invention, video encoding method and apparatus for encoding a plurality of video data inputs including at least one three-dimensional anaglyph video, and related video decoding method and apparatus are proposed to solve the above-mentioned problems.

According to a first aspect of the present invention, an exemplary video encoding method is disclosed. The exemplary video encoding method includes: receiving a plurality of video data inputs corresponding to a plurality of video display formats, respectively, wherein the video display formats include a first three-dimensional (3D) anaglyph video; generating a combined video data by combining video contents derived from the video data inputs; and generating an encoded video data by encoding the combined video data.

According to a second aspect of the present invention, an exemplary video decoding method is disclosed. The exemplary video decoding method includes: receiving an encoded video data having encoded video contents of a plurality of video data inputs combined therein, wherein the video data inputs correspond to a plurality of video display formats, respectively, and the video display formats include a first three-dimensional (3D) anaglyph video; and generating a decoded video data by decoding the encoded video data.

According to a third aspect of the present invention, an exemplary video encoder is disclosed. The exemplary video encoder includes a receiving unit, a processing unit, and an encoding unit. The receiving unit is arranged for receiving a plurality of video data inputs corresponding to a plurality of video display formats, respectively, wherein the video display formats include a first three-dimensional (3D) anaglyph video. The processing unit is arranged for generating a combined video data by combining video contents derived from the video data inputs. The encoding unit is arranged for generating an encoded video data by encoding the combined video data.

According to a fourth aspect of the present invention, an exemplary video decoder is disclosed. The exemplary video decoder includes a receiving unit and a decoding unit. The receiving unit is arranged for receiving an encoded video data having encoded video contents of a plurality of video data inputs combined therein, wherein the video data inputs correspond to a plurality of video display formats, respectively, and the video display formats include a first three-dimensional (3D) anaglyph video. The decoding unit is arranged for generating a decoded video data by decoding the encoded video data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a simplified video system according to an embodiment of the present invention.

FIG. 2 is a diagram illustrating a first example of a spatial domain based combining method employed by a processing unit shown in FIG. 1.

FIG. 3, which is a diagram illustrating a second example of the spatial domain based combining method employed by the processing unit.

FIG. 4 is a diagram illustrating a third example of the spatial domain based combining method employed by the processing unit.

FIG. 5 is a diagram illustrating a fourth example of the spatial domain based combining method employed by the processing unit.

FIG. 6 is a diagram illustrating an example of a temporal domain based combining method employed by the processing unit.

FIG. 7 is a diagram illustrating an example of a file container (video streaming) based combining method employed by the processing unit.

FIG. 8 is a diagram illustrating an example of a file container (separated video streams) based combining method employed by the processing unit.

FIG. 9 is a flowchart illustrating a video switching method of switching between different video display formats according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

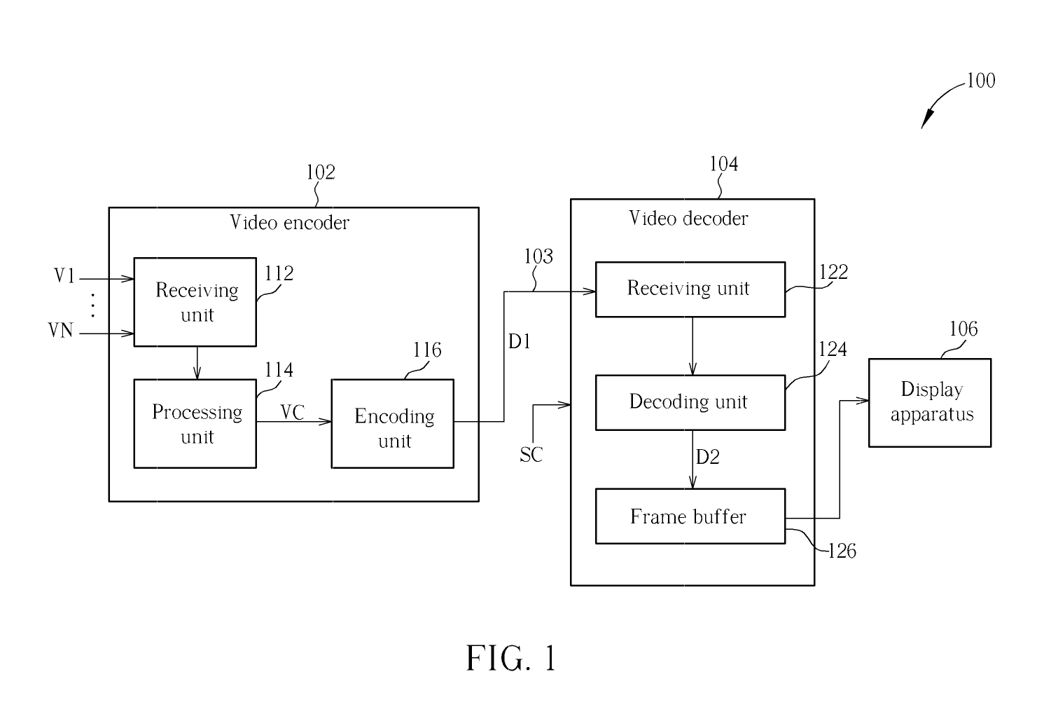

FIG. 1 is a diagram illustrating a simplified video system according to an embodiment of the present invention. The simplified video system 100 includes a video encoder 102, a transmission medium 103, a video decoder 104, and a display apparatus 106. The video encoder 102 employs a proposed video encoding method for generating an encoded video data D1, and includes a receiving unit 112, a processing unit 114, and an encoding unit 116. The receiving unit 112 is arranged for receiving a plurality of video data inputs V1-VN corresponding to a plurality of video display formats, respectively, wherein the video display formats include a three-dimensional (3D) anaglyph video. The processing unit 114 is arranged for generating a combined video data VC by combining video contents derived from the video data inputs V1-VN. The encoding unit 116 is arranged for generating the encoded video data D1 by encoding the combined video data VC.

The transmission medium 103 may be any data carrier capable of delivering the encoded video data D1 from the video encoder 102 to the video decoder 104. For example, the transmission medium 103 may be a storage medium (e.g., an optical disc), a wired connection, or a wireless connection.

The video decoder 104 is used to generate a decoded video data D2, and includes a receiving unit 122, a decoding unit 124, and a frame buffer 126. The receiving unit 122 is arranged for receiving the encoded video data D1 having encoded video contents of video data inputs V1-VN combined therein. The decoding unit 124 is arranged for generating the decoded video data D2 to the frame buffer 126 by decoding the encoded video data D1. After the decoded video data D2 is available in the frame buffer 126, video frame data is derived from the decoded video data D2 and transmitted to the display apparatus 106 for playback.

As mentioned above, the video display formats of the video data inputs V1-VN to be processed by the video encoder 102 include one 3D anaglyph video. In a first operational scenario, the video display formats may include one 3D anaglyph video and a two-dimensional (2D) video. In a second operational scenario, the video display formats may include a first 3D anaglyph video and a second 3D anaglyph video, where the first 3D anaglyph video and the second 3D anaglyph video utilize different complementary color pairs (e.g., color pairs selected from Red-Cyan, Amber-Blue, Green-Magenta, etc.), respectively. In a third operational scenario, the video display formats may include a first 3D anaglyph video and a second 3D anaglyph video, where the first 3D anaglyph video and the second 3D anaglyph video utilizes the same complementary color pair, and the first 3D anaglyph video and the second 3D anaglyph video have different disparity settings for the same video content, respectively. To put it simply, the video encoder 102 is capable of providing an encoded video data having encoded video contents of different video data inputs combined therein, Hence, the user can switch between different video display formats according to his/her viewing preference. For example, the video decoder 104 may enable switching from one video display format to another video display format according to a switch control signal SC, such as a user input. In this way, the user is capable of having improved 2D/3D viewing experience. Besides, as each of the video display formats is either a 2D video or a 3D anaglyph video, the video decoding complexity is low, leading to a simplified design of the video decoder 104. Further details of the video encoder 102 and the video decoder 104 would be described as below.

Regarding the processing unit 114 implemented in the video encoder 102, it may generate the combined video data VC by employing one of a plurality of exemplary combining methods proposed by the present invention, such as a spatial domain based combining method, a temporal domain based combining method, a file container (video streaming) based combining method, and a file container (separated video streams) based combining method.

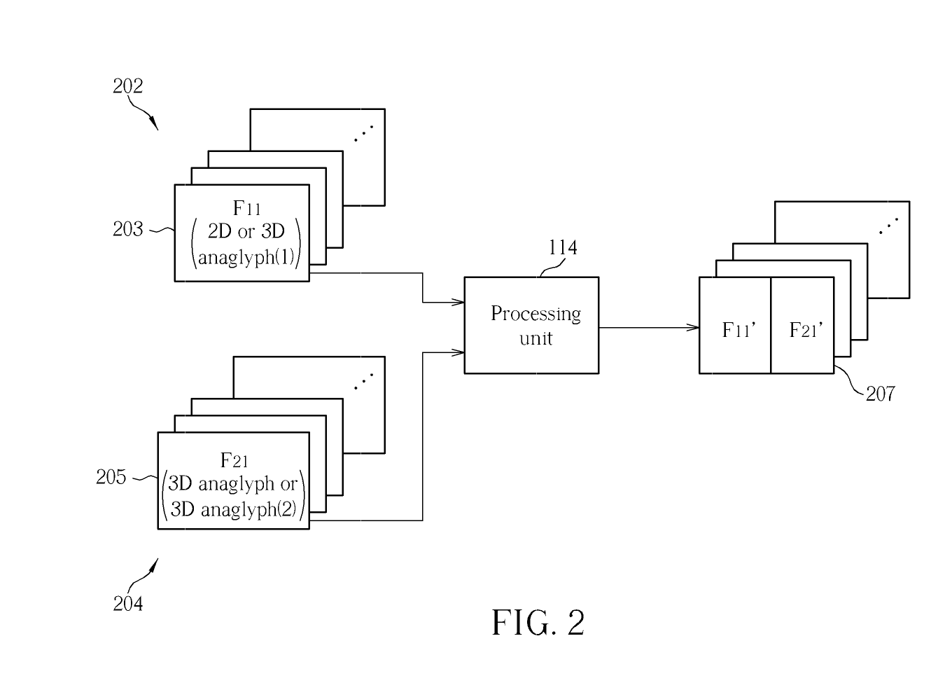

Please refer to FIG. 2, which is a diagram illustrating a first example of the spatial domain based combining method employed by the processing unit 114 shown in FIG. 1. Suppose that the number of aforementioned video data inputs V1-VN is two. As shown in FIG. 2, one video data input 202 includes a plurality of video frames 203, and the other video data input 204 includes a plurality of video frames 205. The video data input 202 may be a 2D video, and the video data input 204 may be a 3D anaglyph video. Alternatively, the video data input 202 may be a first 3D anaglyph video (denoted as ‘3D anaglyph (1)’), and the video data input 204 may be a second 3D anaglyph video (denoted as ‘3D anaglyph (2)’), where the first 3D anaglyph video and the second 3D anaglyph video utilize different complementary color pairs, or utilize the same complementary color pair but have different disparity settings for the same video content. The processing unit 114 in FIG. 2 is arranged to combine video contents (e.g., F₁₁′ and F₂₁′) derived from video frames (e.g., F₁₁ and F₂₁) respectively corresponding to the video data inputs 202 and 204 to generate one video frame 207 of the combined video data. More specifically, a side-by side (left and right) frame packing format is employed to create each of the video frames 207 included in the combined video data generated from the processing unit 114. As can be readily seen from FIG. 2, the video content F₁₁′ is derived from the video frame F₁₁, for example, by using part of the video frame F₁₁ or a scaling result of the video frame F₁₁, and placed in the left part of the video frame 207, and the video content F₂₁′ is derived from the video frame F₂₁, for example, by using part of the video frame F₂₁ or a scaling result of the video frame F₂₁, and placed in the right part of the video frame 207. In this example shown in FIG. 2, the video frames 203, 205, 207 have the same frame size (i.e., the same vertical image resolution and horizontal image resolution). Hence, the side-by side (left and right) frame packing format would preserve vertical image resolution of the video frame 203/205, but cuts the horizontal image resolution of the video frame 203/205 in half. However, this is for illustrative purposes only. In an alternative design, the side-by side (left and right) frame packing format may preserve vertical image resolution and horizontal image resolution of the video frame 203/205, which makes the horizontal image resolution of the video frame 207 twice that of the video frame 203/205.

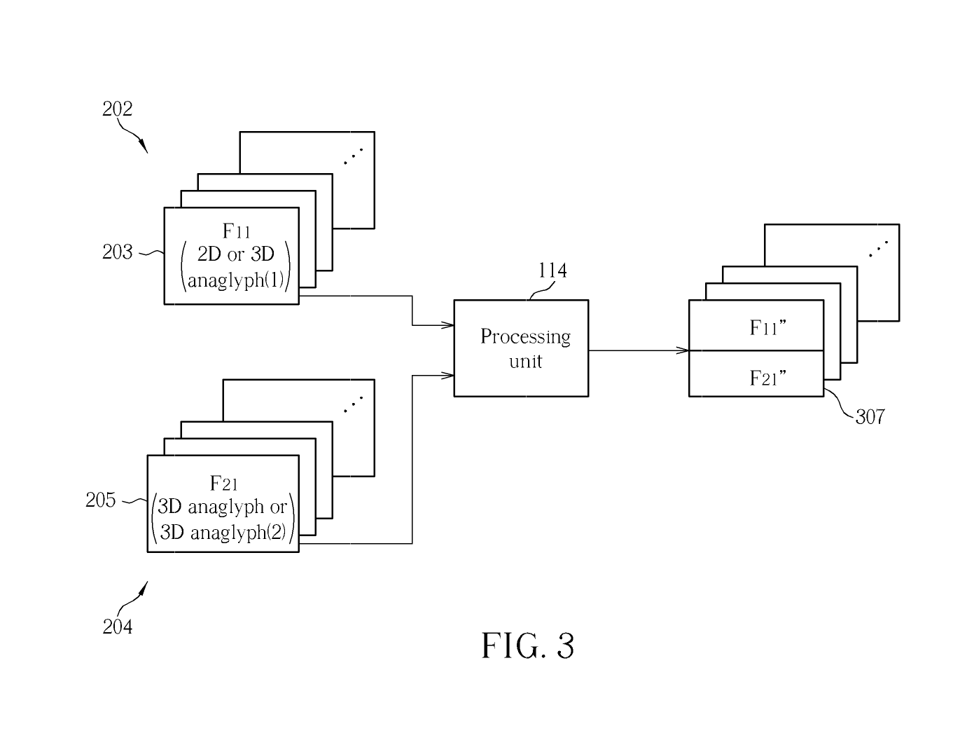

Please refer to FIG. 3, which is a diagram illustrating a second example of the spatial domain based combining method employed by the processing unit 114. As shown in FIG. 3, the processing unit 114 combines video contents (e.g., F₁₁″ and F₂₁″) derived from video frames (e.g., F₁₁ and F₂₁) respectively corresponding to the video data inputs 202 and 204 to generate one video frame 307 of the combined video data, where a top and bottom frame packing format is employed to create each of the video frames 307 included in the combined video data generated from the processing unit 114. Therefore, the video content F₁₁″ is derived from the video frame F₁₁, for example, by using part of the video frame F₁₁ or a scaling result of the video frame F₁₁, and placed in the top part of the video frame 307, and the video content F₂₁″ is derived from the video frame F₂₁, for example, by using part of the video frame F₂₁ or a scaling result of the video frame F₂₁, and placed in the bottom part of the video frame 307. In this example shown in FIG. 3, the video frames 203, 205, 307 have the same frame size (i.e., the same vertical image resolution and horizontal image resolution). Hence, the top and bottom frame packing format would preserve horizontal image resolution of the video frame 203/205, but cuts the vertical image resolution of the video frame 203/205 in half. However, this is for illustrative purposes only. In an alternative design, the top and bottom frame packing format may preserve vertical image resolution and horizontal image resolution of the video frame 203/205, which makes the vertical image resolution of the video frame 307 twice that of the video frame 203/205.

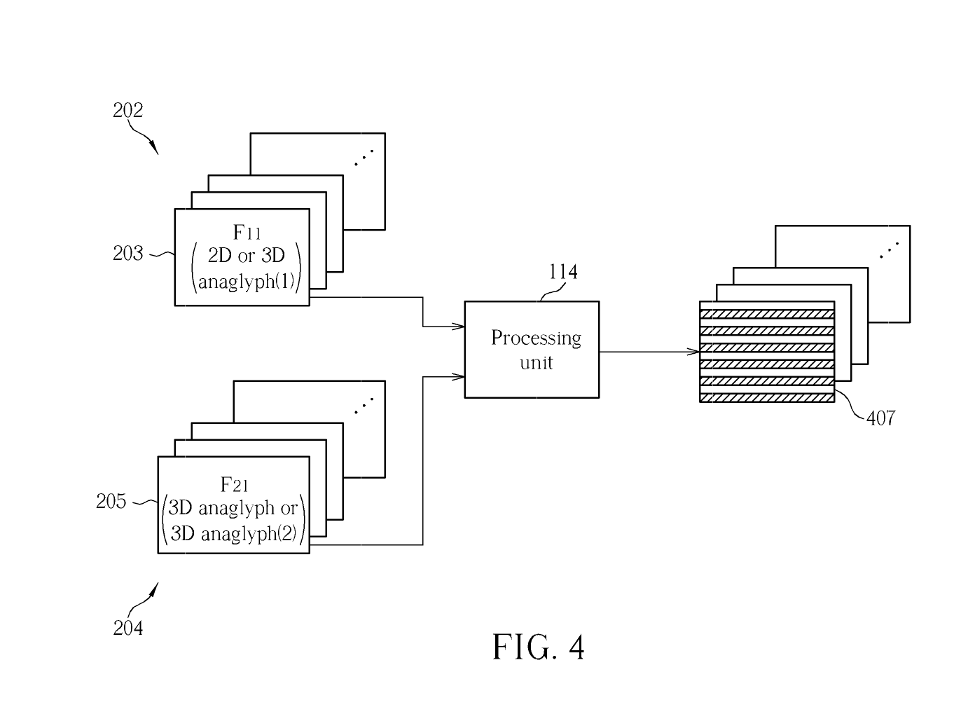

Please refer to FIG. 4, which is a diagram illustrating a third example of the spatial domain based combining method employed by the processing unit 114. As shown in FIG. 4, an interleaved frame packing format is employed to create each of the video frames 407 included in the combined video data generated from the processing unit 114. Therefore, odd lines of the video frame 407 are pixel rows derived (e.g., selected or scaled) from the video frame F₁₁, and even lines of the video frame 407 are pixel rows derived (e.g., selected or scaled) from the video frame F₂₁. In this example shown in FIG. 4, the video frames 203, 205, 407 have the same frame size (i.e., the same vertical image resolution and horizontal image resolution). Hence, the interleaved frame packing format would preserve horizontal image resolution of the video frame 203/205, but cuts the vertical image resolution of the video frame 203/205 in half. However, this is for illustrative purposes only. In an alternative design, the interleaved frame packing format may preserve vertical image resolution and horizontal image resolution of the video frame 203/205, which makes the vertical image resolution of the video frame 407 twice that of the video frame 203/205.

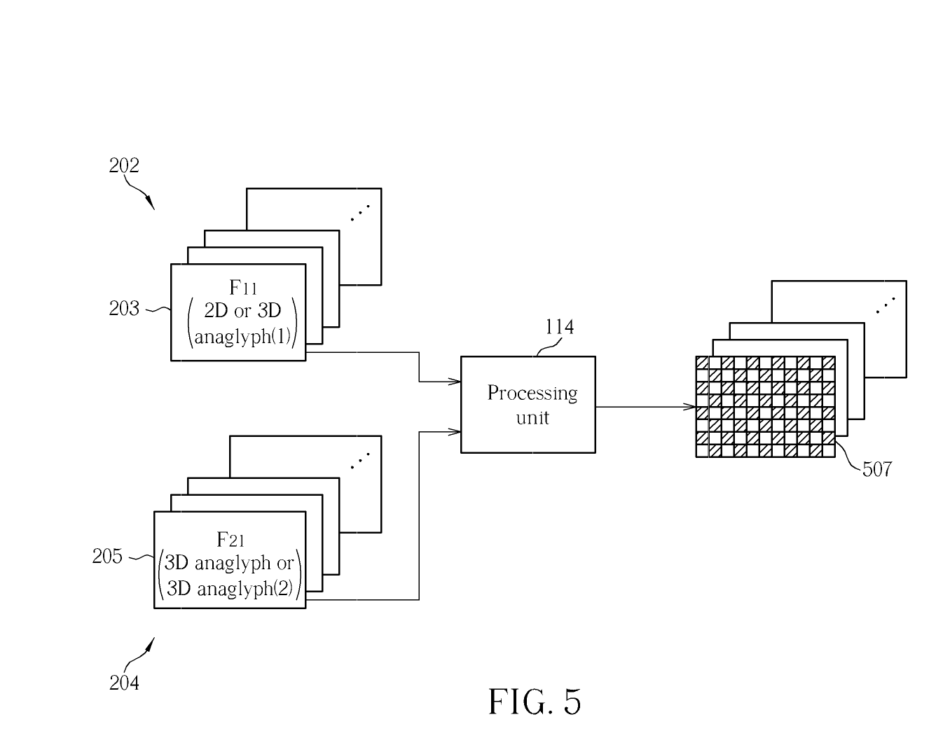

Please refer to FIG. 5, which is a diagram illustrating a fourth example of the spatial domain based combining method employed by the processing unit 114. As shown in FIG. 5, a checkerboard frame packing format is employed to create each of the video frames 507 included in the combined video data generated from the processing unit 114. Therefore, odd pixels located in odd lines of the video frame 507 and even pixels located in even lines of the video frame 507 are pixels derived (e.g., selected or scaled) from the video frame F₁₁, and even pixels located in odd lines of the video frame 507 and odd pixels located in even lines of the video frame 507 are pixels derived (e.g., selected or scaled) from the video frame F₂₁. In this example shown in FIG. 5, the video frames 203, 205, 507 have the same frame size (i.e., the same vertical image resolution and horizontal image resolution). Hence, the checkerboard frame packing format would cut the vertical and horizontal image resolution of the video frame 203/205 in half. However, this is for illustrative purposes only. In an alternative design, the checkerboard interleaved frame packing format may preserve vertical image resolution and horizontal image resolution of the video frame 203/205, which makes the horizontal and vertical image resolution of the video frame 507 twice that of the video frame 203/205.

As mentioned above, the combined video data VC generated from the processing unit 114 by processing the video data inputs (e.g., 202 and 204) is encoded by the encoding unit 116 as the encoded video data D1. After each encoded video frame of the encoded video data D1 is decoded by the decoding unit 124 implemented in the video decoder 104, a decoded video frame would have the video contents respectively corresponding to the video data inputs (e.g., 202 and 204). If the side-by side frame packing method is employed by the processing unit 114, the whole encoded video frames are decoded by the decoding unit 124. Hence, the video frames 207 shown in FIG. 2 are sequentially obtained by the decoding unit 124 and then stored into the frame buffer 126.

When the user desires to view the 2D display, the left part of the video frame 207 stored in the frame buffer 126 is retrieved to act as the video frame data, and transmitted to the display apparatus 106 for playback. When the user desires to view the 3D anaglyph display, the right part of the video frame 207 stored in the frame buffer 126 is retrieved to act as the video frame data, and transmitted to the display apparatus 106 for playback.

In an alternative design, when the user desires to view the first 3D anaglyph display which uses designated complementary color pairs or designated disparity setting, the left part of the video frame 207 stored in the frame buffer 126 is retrieved to act as the video frame data, and transmitted to the display apparatus 106 for playback. When the user desires to view the second 3D anaglyph display which uses designated complementary color pairs or designated disparity setting, the right part of the video frame 207 stored in the frame buffer 126 is retrieved to act as the video frame data, and transmitted to the display apparatus 106 for playback.

As a person skilled in the art can readily understand the playback operation of the video frames 307/407/507 after reading above paragraph, further description is omitted here for brevity.

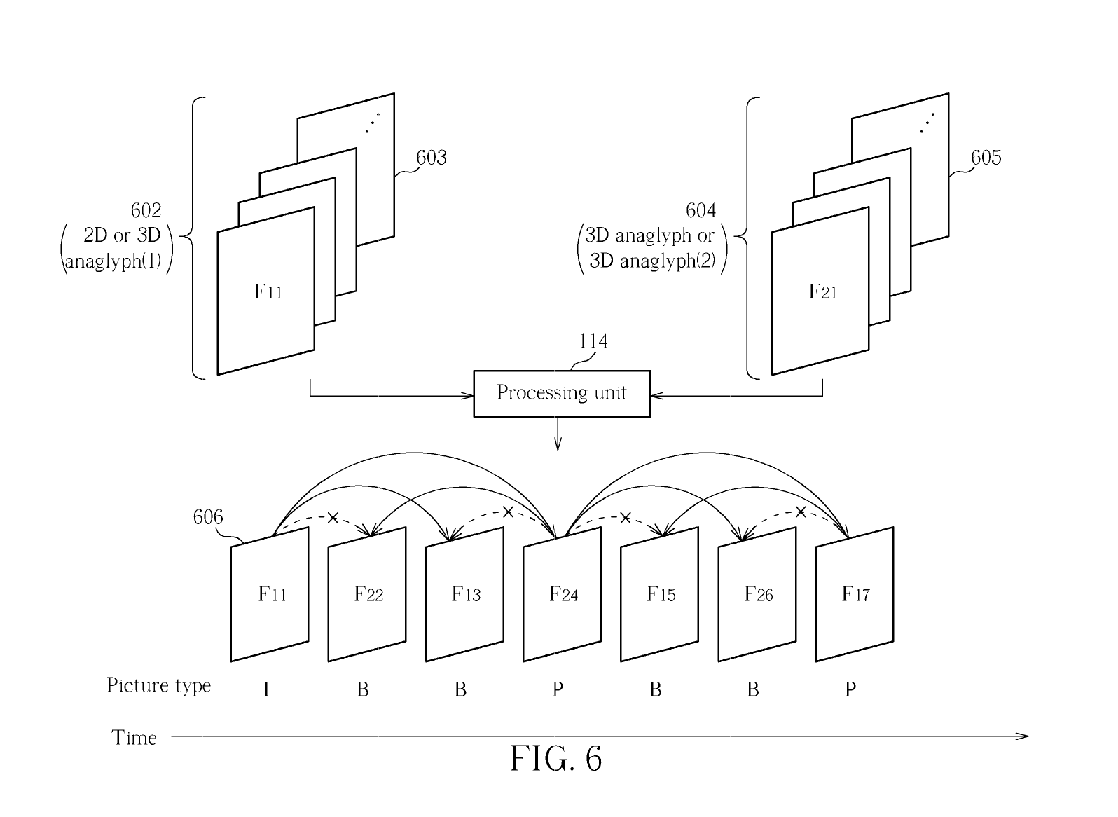

Please refer to FIG. 6, which is a diagram illustrating an example of the temporal domain based combining method employed by the processing unit 114. Suppose that the number of aforementioned video data inputs V1-VN is two. As shown in FIG. 6, one video data input 602 includes a plurality of video frames 603 (F₁₁, F₁₂, F₁₃, F₁₄, F₁₅, F₁₆, F₁₇, . . . ), and the other video data input 604 includes a plurality of video frames 605 (F₂₁, F₂₂, F₂₃, F₂₄, F₂₅, F₂₆, F₂₇, . . . ). The video data input 602 may be a 2D video, and the video data input 604 may be a 3D anaglyph video. Alternatively, the video data input 602 may be a first 3D anaglyph video (denoted as ‘3D anaglyph (1)’), and the video data input 604 may be a second 3D anaglyph video (denoted as ‘3D anaglyph (2)’), where the first 3D anaglyph video and the second 3D anaglyph video utilize different complementary color pairs, or utilize the same complementary color pair but have different disparity settings for the same video content. The processing unit 114 shown in FIG. 6 utilizes video frames F₁₁, F₁₃, F₁₅, F₁₇, F₂₂, F₂₄, and F₂₆ of the video data inputs 602 and 604 as video frames 606 of the combined video data. More specifically, the processing unit 114 generates successive video frames 606 of the combined video data by arranging video frames 603 and 605 respectively corresponding to the video data inputs 602 and 604. Hence, the video frames F₁₁, F₁₃, F₁₅ and F₁₇ derived from the video data input 602 and the video frames F₂₂, F₂₄, and F₂₆ derived from the video data input 604 are time-interleaved in the same video stream. In this example shown in FIG. 6, a portion of the video frames 603 in the video data input 602 and a portion of the video frames 605 in the video data input 604 are combined in a time-interleaved manner. Thus, compared to the video frames 603 in the video data input 602, the selected video frames (e.g., F₁₁, F₁₃, F₁₅, and F₁₇) of the video data input 602 in the combined video data generated from the processing unit 114 would have a lower frame rate when displayed. Similarly, compared to the video frames 605 in the video data input 604, the selected video frames (e.g., F₂₂, F₂₄, and F₂₆) of the video data input 604 in the combined video data generated from the processing unit 114 would have a lower frame rate when displayed. However, this is for illustrative purposes only. In an alternative design, all video frames 603 included in the video data input 602 and all video frames 605 included in the video data input 604 may be combined in a time-interleaved manner, thus making the frame rate unchanged.

As mentioned above, the combined video data VC generated from the processing unit 114 by processing the video data inputs (e.g., 602 and 604) is encoded by the encoding unit 116 as the encoded video data D1. When processed by the encoding unit 116 complying with a specific video standard, the video frame F₁₁ may an intra-coded frame (I-frame), the video frames F₂₂, F₁₃, F₁₅, and F₂₆ may be bidirectionally predictive coded frames (B-frames), and the video frames F₂₄ and F₁₇ may be predictive coded frames (P-frames). In general, encoding of a B-frame may use a previous I-frame or a next P-frame as a reference frame needed by inter-frame prediction, and encoding of a P-frame may use a previous I-frame or a previous P-frame as a reference frame needed by inter-frame prediction. Hence, when encoding the video frame F₂₂, the encoding unit 116 is allowed to refer to the video frame F₁₁ or the video frame F₂₄ for inter-frame prediction. However, the video frames F₂₂ and F₂₄ belong to the same video data input 604, and the video frames F₁₁ and F₂₂ belong to different video data inputs 602 and 604, where the video data inputs 602 and 604 have different video display formats. Therefore, when the video frame F₂₂ is encoded using inter-frame prediction, selecting the video frame F₁₁ as a reference frame would result in poor coding efficiency. Similarly, selecting the video frame F₂₄ as a reference frame would result in poor coding efficiency when the video frame F₁₃ is encoded using inter-frame prediction, selecting the video frame F₂₄ as a reference frame would result in poor coding efficiency when the video frame F₁₅ is encoded using inter-frame prediction, and selecting the video frame F₁₇ as a reference frame would result in poor coding efficiency when the video frame F₂₆ is encoded using inter-frame prediction.

To achieve efficient frame encoding, the present invention proposes that a 3D anaglyph frame is preferably predicted from a 3D anaglyph frame, and a 2D frame is preferably predicted from a 2D frame. To put it another way, when a first video frame (e.g., F₂₄) of a first video data input (e.g., 604) and a video frame (e.g., F₁₁) of a second video data input (e.g., 602) are available for an inter-frame prediction that is required to encode a second video frame (e.g., F₂₂) of the first video data input (e.g., 604), the encoding unit 116 performs the inter-frame prediction according to the first video frame (e.g., F₂₄) and the second video frame (e.g., F₂₂) for better coding efficiency. Based on the above encoding rule, the encoding unit 116 would perform inter-frame prediction according to the video frames F₁₁ and F₁₃, perform inter-frame prediction according to the video frames F₁₅ and F₁₇, and perform inter-frame prediction according to the video frames F₂₄ and F₂₆, as illustrated in FIG. 6. In addition, information of the reference frames used by inter-frame prediction is recorded in syntax elements contained in the encoded video data D1. Thus, based on information of the reference frames that is derived from the encoded video data D1, the decoding unit 124 is capable of correctly and easily reconstructing the video frames F₂₂, F₁₃, F₁₅, and F₂₆.

After successive encoded video frames of the encoded video data D1 are decoded by the decoding unit 124, decoded video frames are sequentially generated. Hence, the video frames 606 shown in FIG. 6 are sequentially obtained by the decoding unit 124 and then stored into the frame buffer 126.

When the user desires to view the 2D display, video frames (e.g., F₁₁, F₁₃, F₁₅, and F₁₇) of the video data input 602 would be sequentially retrieved from the frame buffer 126 to act as the video frame data, and transmitted to the display apparatus 106 for playback. When the user desires to view the 3D anaglyph display, video frames (e.g., F₂₂, F₂₄, and F₂₆) of the video data input 604 would be sequentially retrieved from the frame buffer 126 to act as the video frame data, and transmitted to the display apparatus 106 for playback.

In an alternative design, when the user desires to view the first 3D anaglyph display using designated complementary color pairs or designated disparity setting, video frames (e.g., F₁₁, F₁₃, F₁₅, and F₁₇) of the video data input 602 would be sequentially retrieved from the frame buffer 126 to act as the video frame data, and transmitted to the display apparatus 106 for playback. When the user desires to view the second 3D anaglyph display using designated complementary color pairs or designated disparity setting, video frames (e.g., F₂₂, F₂₄, and F₂₆) of the video data input 604 would be sequentially retrieved from the frame buffer 126 to act as the video frame data, and transmitted to the display apparatus 106 for playback.

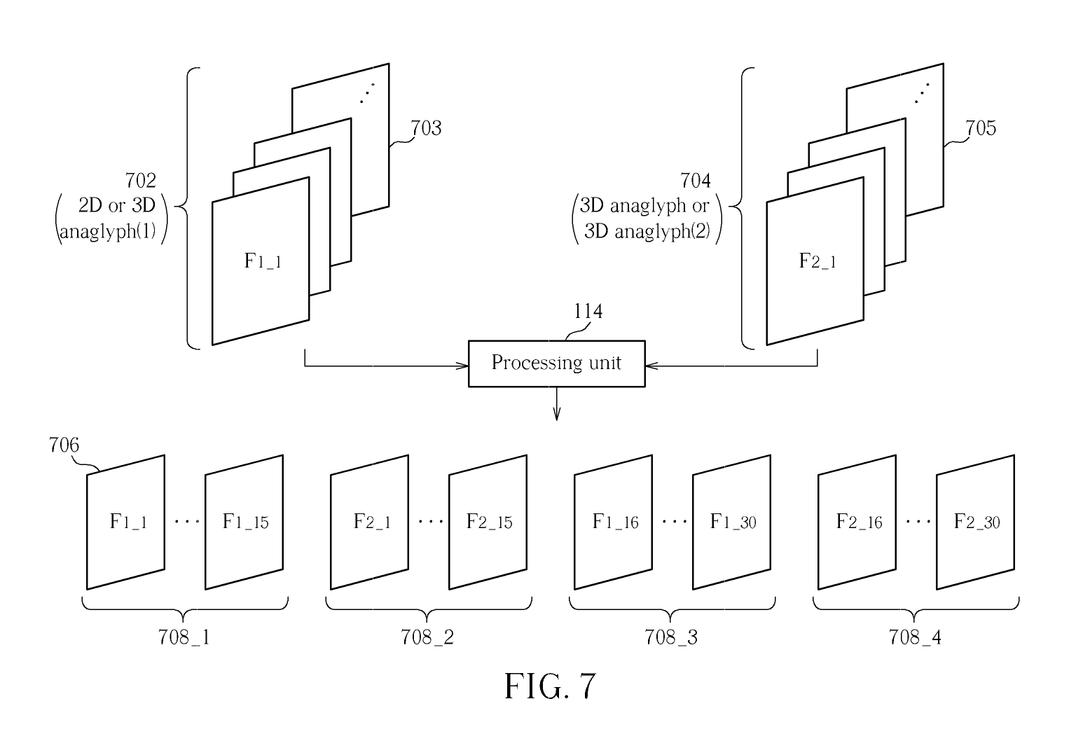

Please refer to FIG. 7, which is a diagram illustrating an example of the file container (video streaming) based combining method employed by the processing unit 114. Suppose that the number of aforementioned video data inputs V1-VN is two. As shown in FIG. 7, one video data input 702 includes a plurality of video frames 703 (F₁_{_{—}}₁-F₁_{_{—}}₃₀), and the other video data input 704 includes a plurality of video frames 705 (F₂_{_{—}}₁-F₂_{_{—}}₃₀). The video data input 702 may be a 2D video, and the video data input 704 may be a 3D anaglyph video. Alternatively, the video data input 702 may be a first 3D anaglyph video (denoted as ‘3D anaglyph (1)’), and the video data input 704 may be a second 3D anaglyph video (denoted as ‘3D anaglyph (2)’), where the first 3D anaglyph video and the second 3D anaglyph video utilize different complementary color pairs, or utilize the same complementary color pair but have different disparity settings for the same video content. The processing unit 114 in FIG. 7 utilizes video frames (e.g., F₁_{_{—}}₁-F₁_{_{—}}₃₀) of the video data input 702 and video frames (e.g., F₂_{_{—}}₁-F₂_{_{—}}₃₀) of the video data input 704 as video frames 706 of the combined video data. More specifically, the processing unit 114 generates successive video frames 706 of the combined video data by arranging picture groups 708_1, 708_2, 708_3, 708_4 respectively corresponding to the video data inputs 702 and 704, where each of the picture groups 708_1-708_4 includes more than one video frame (e.g., fifteen video frames). Hence, the picture groups 708_1-708_4 are time-interleaved in the same video stream. Besides, the video frames number of the combined video data generated from the processing unit 114 is equal to the sum of video frame numbers of the video data inputs 702 and 704. However, this is for illustrative purposes only, and is not meant to be a limitation of the present invention.

As mentioned above, the combined video data VC generated from the processing unit 114 by processing the video data inputs (e.g., 702 and 704) is encoded by the encoding unit 116 as the encoded video data D1. To facilitate the selecting and decoding of the desired video content (e.g., 2D/3D anaglyph, or 3D anaglyph (1)/3D anaglyph (2)) in the video decoder 104, the picture groups 708_1-708_4 in the video encoder 102 may be packaged using different packaging settings. In other words, each of the picture groups 708_1 and 708_3 includes video frames derived from the video data input 702 and is encoded according to a first packaging setting, while each of the picture groups 708_2 and 708_4 includes video frames derived from the video data input 704 and is encoded according to a second packaging setting that is different from the first packaging setting. In one exemplary design, each of the picture groups 708_1 and 708_3 may be packaged by a general start code of the employed video encoding standard (e.g., MPEG, H.264, or VP), and each of the picture groups 708_2 and 708_4 may be packaged by a reserved start code of the employed video encoding standard (e.g., MPEG, H.264, or VP). In another exemplary design, each of the picture groups 708_1 and 708_3 may be packaged as video data of the employed video encoding standard (e.g., MPEG, H.264, or VP), and each of the picture groups 708_2 and 708_4 may be packaged as user data of the employed video encoding standard (e.g., MPEG, H.264, or VP). In yet another exemplary design, the picture groups 708_1 and 708_3 may be packaged using first AVI (Audio/Video Interleaved) chunks, and the picture groups 708_2 and 708_4 may be packaged using second AVI chunks.

It should be noted that the picture groups 708_1-708_4 are not required to be encoded in the same video standard. In other words, the encoding unit 116 in the video encoder 102 may be configured to encode the picture groups 708_1 and 708_3 of the video data input 702 according to a first video standard, and encode the picture groups 708_2 and 708_4 of the video data input 704 according to a second video standard that is different from the first video standard. Besides, the decoding unit 124 in the video decoder 104 should also be properly configured to decode encoded picture groups of the video data input 702 according to the first video standard, and decode encoded picture groups of the video data input 704 according to the second video standard.

Regarding the decoding operation applied to the encoded video data derived from encoding the combined video data that is generated by either the spatial domain based combining method or the temporal domain based combining method, each of the encoded video frames included in the encoded video data would be decoded in the video decoder 204, and then the desired frame data to be displayed is selected from the decoded video data buffered in the frame buffer 126. However, regarding the decoding operation applied to the encoded video data derived from encoding the combined video data that is generated by the file container (video streaming) based combining method, it is not required to decode each of the encoded video frames included in the encoded video data. Specifically, as the encoded picture groups can be identified by the employed packaging settings (e.g., general start code and reserved start code/user data and video data/different AVI chunks), the decoding unit 124 may only decode needed picture groups without decoding all of the picture groups included in the video stream. For example, the decoding unit 124 receives the switch control signal SC indicating which one of the video data inputs is desired, and only decodes the encoded pictures of a desired video data input indicated by the switch control signal SC, where the switch control signal SC may be generated in response to a user input. Therefore, the decoding unit 124 may only decode the encoded picture groups of the video data input 702 and sequentially store the obtained video frames (e.g., F₁_{_{—}}₁-F₁_{_{—}}₃₀) to the frame buffer 126 when the user desires to view the 2D display, and may only decode the encoded picture groups of the video data input 704 and sequentially store the obtained video frames (e.g., F₂_{_{—}}₁-F₂_{_{—}}₃₀) to the frame buffer 126 when the user desires to view the 3D anaglyph display.

In an alternative design, the decoding unit 124 may only decode the encoded picture groups of the video data input 702 and sequentially store the obtained video frames (e.g., F₁_{_{—}}₁-F₁_{_{—}}₃₀) to the frame buffer 126 when the user desires to view the first 3D anaglyph display using designated complementary color pairs or designated disparity setting, and may only decode the encoded picture groups of the video data input 704 and sequentially store the obtained video frames (e.g., F₂_{_{—}}₁-F₂_{_{—}}₃₀) to the frame buffer 126 when the user desires to view the second 3D anaglyph display using designated complementary color pairs or designated disparity setting.

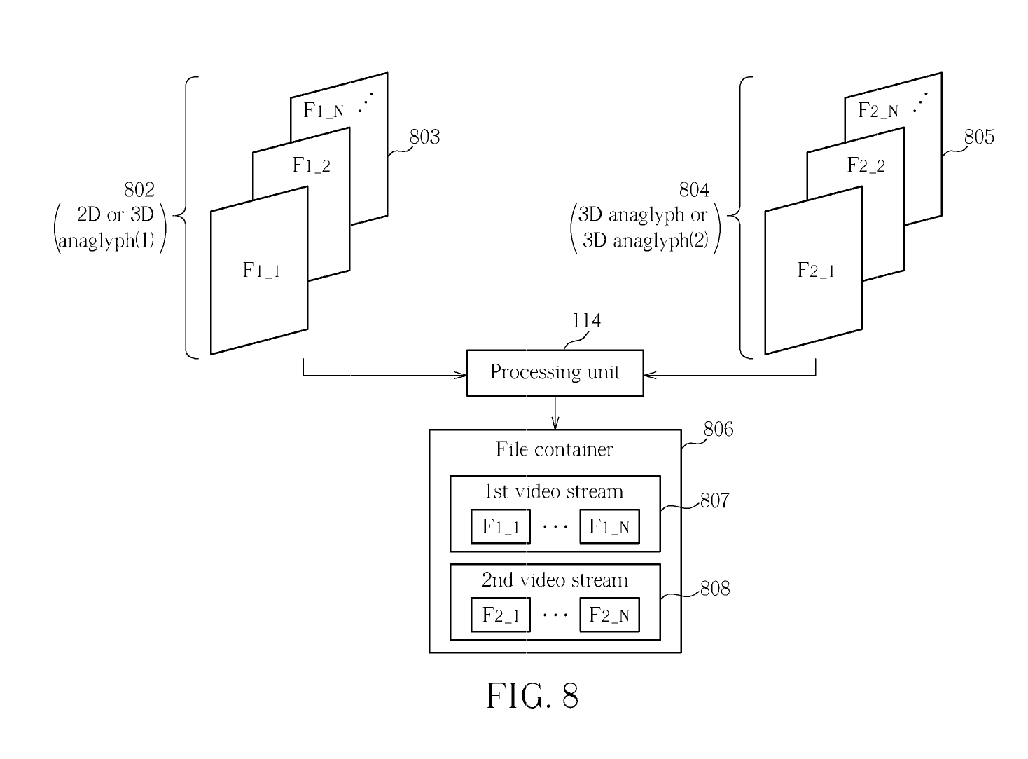

Please refer to FIG. 8, which is a diagram illustrating an example of the file container (separated video streams) based combining method employed by the processing unit 114. Suppose that the number of aforementioned video data inputs V1-VN is two. As shown in FIG. 8, one video data input 802 includes a plurality of video frames 803 (F₁_{_{—}}₁-F₁_{_{—}}_{N}), and the other video data input 804 includes a plurality of video frames 805 (F₂_{_{—}}₁-F₂_{_{—}}_{N}). The video data input 802 may be a 2D video, and the video data input 804 may be a 3D anaglyph video. Alternatively, the video data input 802 may be a first 3D anaglyph video (denoted as ‘3D anaglyph (1)’), and the video data input 804 may be a second 3D anaglyph video (denoted as ‘3D anaglyph (2)’), where the first 3D anaglyph video and the second 3D anaglyph video utilize different complementary color pairs or utilize the same complementary color pair but have different disparity settings for the same video content. The processing unit 114 in FIG. 8 utilizes video frames F₁_{_{—}}₁-F₁_{_{—}}_{N} of the video data input 802 and video frames F₂_{_{—}}₁-F₂_{_{—}}_{N} of the video data input 804 as video frames of the combined video data. More specifically, the processing unit 114 generates the combined video data by combining a plurality of video streams (e.g., the first video stream 807 and the second video stream 808) respectively corresponding to the video data inputs (e.g., 802 and 804), where each of the video streams 807 and 808 includes all video frames of a corresponding video data input 802/804, as shown in FIG. 8.

As mentioned above, the combined video data VC generated from the processing unit 114 by processing the video data inputs (e.g., 802 and 804) is encoded by the encoding unit 116 as the encoded video data D1. It should be noted that the first video stream 807 and the second video stream 808 are not required to be encoded in the same video standard. For example, the encoding unit 116 in the video encoder 102 may be configured to encode the first video stream 807 of the video data input 802 according to a first video standard, and encode the second video stream 808 of the video data input 804 according to a second video standard that is different from the first video standard. Besides, the decoding unit 124 in the video decoder 104 should also be properly configured to decode encoded video stream of the video data input 802 according to the first video standard, and decode encoded video stream of the video data input 804 according to the second video standard.

As the there are two encoded video streams separately present in the same file container 806, the decoding unit 124 may only decode the needed video stream without decoding all of the video streams included in the same file container. For example, the decoding unit 124 receives the switch control signal SC indicating which one of the video data inputs is desired, and only decodes the encoded video stream of a desired video data input indicated by the switch control signal SC, where the control signal SC may be generated in response to a user input. Therefore, the decoding unit 124 may only decode the encoded video stream of the video data input 802 and sequentially store the desired video frames (e.g., some or all of the video frames F₁_{_{—}}₁-F₁_{_{—}}_{N}) to the frame buffer 126 when the user desires to view the 2D display, and may only decode the encoded video stream of the video data input 804 and sequentially store the desired video frames (e.g., some or all of the video frames F₂_{_{—}}₁-F₂_{_{—}}_{N}) to the frame buffer 126 when the user desires to view the 3D anaglyph display.

In an alternative design, the decoding unit 124 may only decode the encoded video stream of the video data input 802 and sequentially store the desired video frames (e.g., some or all of the video frames F₁_{_{—}}₁-F₁_{_{—}}_{N}) to the frame buffer 126 when the user desires to view the first 3D anaglyph display which uses designated complementary color pairs or designated disparity setting, and may only decode the encoded video stream of the video data input 804 and sequentially store the desired video frames (e.g., some or all of the video frames F₂_{_{—}}₁-F₂_{_{—}}_{N}) to the frame buffer 126 when the user desires to view the second 3D anaglyph display which uses designated complementary color pairs or designated disparity setting.

As the encoded video streams which carry the same video content are separately present in the same file container 806, the switching between different video display formats has to search for an adequate starting point for decoding a selected video stream. Otherwise, the displayed video content of the video data input 802 always starts from the first video frame F₁_{_{—}}₁ each time the playback of the video data input 802 is selected by the user, and the displayed video content of the video data input 804 always starts from the first video frame F₂_{_{—}}₁ each time the playback of the video data input 804 is selected by the user. Hence, the present invention proposes a video switching method which is capable of providing smooth video playback result.

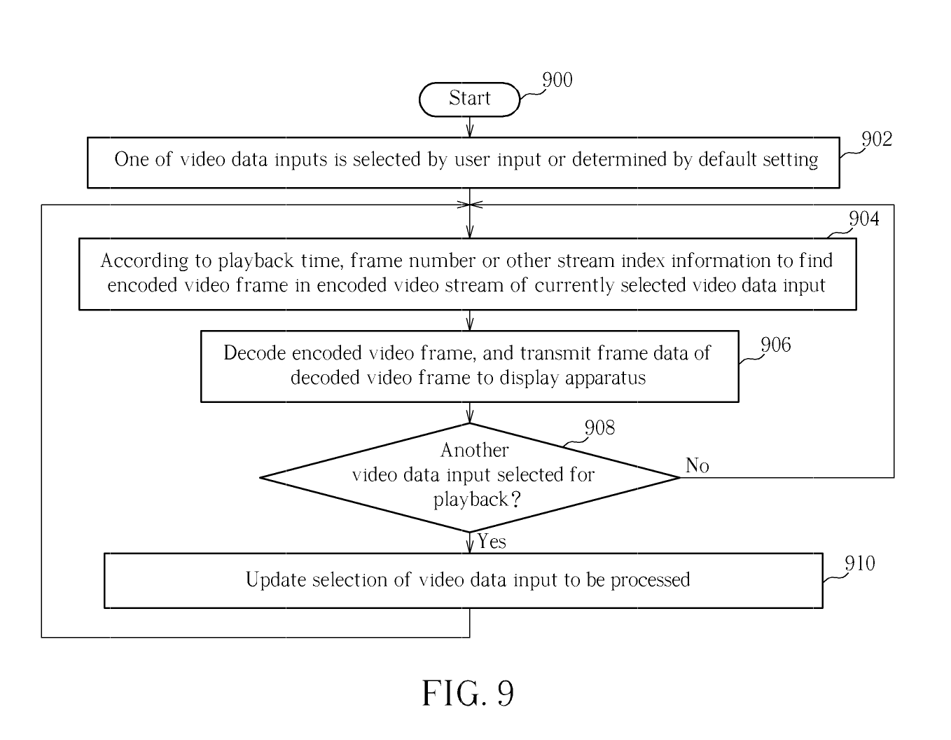

Please refer to FIG. 9, which is a flowchart illustrating a video switching method according to an exemplary embodiment of the present invention. If the result is substantially the same, the steps are not required to be executed in the exact order shown in FIG. 9. The exemplary video switching method may be briefly summarized as below.

Step 900: Start.

Step 902: One of the video data inputs is selected by a user input or determined by a default setting.

Step 904: According to playback time, frame number or other stream index information (e.g., AVI offset) to find an encoded video frame in an encoded video stream of the currently selected video data input.

Step 906: Decode the encoded video frame, and transmit frame data of a decoded video frame to the display apparatus 106 for playback.

Step 908: Check if the user selects another of the video data inputs for playback. If yes, go to step 910; otherwise, go to step 904 to keep processing the next encoded video frame in the encoded video stream of the currently selected video data input.

Step 910: Update the selection of the video data input to be processed in response to the user input which indicates the switching from one video display format to another video display format. Therefore, the newly selected video data input in step 908 would become the currently selected video data input in step 904. Next, go to step 904.

Consider a case where the user is allowed to switch between 2D video playback and 3D anaglyph video playback. When the video data input 802 is selected/determined in step 902, a 2D video is displayed on the display apparatus 106 in steps 904 and 906, and step 908 is used to check if the user selects the video data input 804 for playback of a 3D anaglyph video. However, when the video data input 804 is selected/determined in step 902, a 3D anaglyph video is displayed on the display apparatus 106 in steps 904 and 906, and step 908 is used to check if the user selects the video data input 802 for playback of a 2D video.

Consider another case where the user is allowed to switch between first 3D anaglyph video playback and second 3D anaglyph video playback. When the video data input 802 is selected/determined in step 902, a first 3D anaglyph video using designated complementary color pairs or designated disparity setting is displayed on the display apparatus 106 in steps 904 and 906, and step 908 is used to check if the user selects the video data input 804 for playback of a second 3D anaglyph video using designated complementary color pairs or designated disparity setting. However, when the video data input 804 is selected/determined in step 902, a second 3D anaglyph video designated complementary color pairs or disparity setting is displayed on the display apparatus 106 in steps 904 and 906, and step 908 is used to check if the user selects the video data input 802 for playback of a first 3D anaglyph video using designated complementary color pairs or disparity setting.

No matter which of the video data inputs is selected for video playback, step 904 is executed to find an appropriate encoded video frame to be decoded such that the playback of the video content would continue rather than repeat from the beginning. For example, when the video frame F₁_{_{—}}₁ of the video data input 802 is currently displayed and then the user selects the video data input 804 for playback, the step 904 would select an encoded video frame corresponding to the video frame F₂_{_{—}}₂ of the video data input 804. As the video frame F₁_{_{—}}₂ and F₂_{_{—}}₂ have the same video content but different display effects, smooth video playback is realized when switching of different video display formats occurs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding method, comprising:
receiving a plurality of video data inputs corresponding to a plurality of video display formats, respectively, wherein the video display formats include a first three-dimensional (3D) anaglyph video;
generating a combined video data by combining video contents derived from the video data inputs; and
generating an encoded video data by encoding the combined video data.

2. The video encoding method of claim 1, wherein the video display formats further include a two-dimensional (2D) video.

3. The video encoding method of claim 1, wherein the video display formats further include a second 3D anaglyph video.

4. The video encoding method of claim 3, wherein the first 3D anaglyph video and the second 3D anaglyph video utilize different complementary color pairs, respectively.

5. The video encoding method of claim 3, wherein the first 3D anaglyph video and the second 3D anaglyph video utilizes a same complementary color pair, and the first 3D anaglyph video and the second 3D anaglyph video have different disparity settings for a same video content, respectively.

6. The video encoding method of claim 1, wherein each of the video data inputs includes a plurality of video frames, and the step of generating the combined video data comprises:
combining video contents derived from video frames respectively corresponding to the video data inputs to generate one video frame of the combined video data.

7. The video encoding method of claim 1, wherein each of the video data inputs includes a plurality of video frames, and the step of generating the combined video data comprises:
utilizing video frames of the video data inputs as video frames of the combined video data.

8. The video encoding method of claim 7, wherein the step of utilizing video frames of the video data inputs as video frames of the combined video data comprises:
generating successive video frames of the combined video data by arranging video frames respectively corresponding to the video data inputs.

9. The video encoding method of claim 8, wherein the step of generating the encoded video data comprises:
when a first video frame of a first video data input and a video frame of a second video data input are available for an inter-frame prediction that is required to encode a second video frame of the first video data input, performing the inter-frame prediction according to the first video frame and the second video frame.

10. The video encoding method of claim 7, wherein the step of utilizing video frames of the video data inputs as video frames of the combined video data comprises:
generating successive video frames of the combined video data by arranging picture groups respectively corresponding to the video data inputs, wherein each of the picture groups includes a plurality of video frames.

11. The video encoding method of claim 10, wherein the step of generating the encoded video data comprises:
encoding picture groups of a first video data input according to a first packaging setting; and
encoding picture groups of a second video data input according to a second packaging setting different from the first packaging setting.

12. The video encoding method of claim 10, wherein the step of generating the encoded video data comprises:
encoding picture groups of a first video data input according to a first video standard; and
encoding picture groups of a second video data input according to a second video standard different from the first video standard.

13. The video encoding method of claim 7, wherein the step of utilizing video frames of the video data inputs as video frames of the combined video data comprises:
generating the combined video data by combining a plurality of video streams respectively corresponding to the video data inputs, wherein each of the video streams includes all video frames of a corresponding video data input.

14. The video encoding method of claim 13, wherein the step of generating the encoded video data comprises:
encoding a video stream of a first video data input according to a first video standard; and
encoding a video stream of a second video data input according to a second video standard different from the first video standard.

15. A video decoding method, comprising:
receiving an encoded video data having encoded video contents of a plurality of video data inputs combined therein, wherein the video data inputs correspond to a plurality of video display formats, respectively, and the video display formats include a first three-dimensional (3D) anaglyph video; and
generating a decoded video data by decoding the encoded video data.

16. The video decoding method of claim 15, wherein the video display formats further include a two-dimensional (2D) video.

17. The video decoding method of claim 15, wherein the video display formats further include a second 3D anaglyph video.

18. The video decoding method of claim 17, wherein the first 3D anaglyph video and the second 3D anaglyph video utilize different complementary color pairs, respectively.

19. The video decoding method of claim 17, wherein the first 3D anaglyph video and the second 3D anaglyph video utilizes a same complementary color pair, and the first 3D anaglyph video and the second 3D anaglyph video have different disparity settings for a same video content, respectively.

20. The video decoding method of claim 15, wherein the encoded video data includes a plurality of encoded video frames, and the step of generating the decoded video data comprises:
decoding an encoded video frame of the encoded video data to generate a decoded video frame having video contents respectively corresponding to the video data inputs.

21. The video decoding method of claim 15, wherein the encoded video data includes a plurality of successive encoded video frames respectively corresponding to the video data inputs, and the step of generating the decoded video data comprises:
decoding the successive encoded video frames to sequentially generate a plurality of decoded video frames, respectively.

22. The video decoding method of claim 15, wherein the encoded video data includes a plurality of encoded picture groups respectively corresponding to the video data inputs, each of the encoded picture groups includes a plurality of encoded video frames, and the step of generating the decoded video data comprises:
receiving a control signal indicating which one of the video data inputs is desired; and
only decoding encoded picture groups of a desired video data input indicated by the control signal.

23. The video decoding method of claim 22, wherein the encoded picture groups of the desired video data input are selected from the encoded video data by referring to a packaging setting of the encoded picture groups.

24. The video decoding method of claim 22, wherein encoded picture groups of a first video data input are decoded according to a first video standard, and encoded picture groups of a second video data input are decoded according to a second video standard different from the first video standard.

25. The video decoding method of claim 15, wherein the encoded video data includes encoded video streams respectively corresponding to the video data inputs, each of the encoded video streams includes all encoded video frames of a corresponding video data input, and the step of generating the decoded video data comprises:
receiving a control signal indicating which one of the video data inputs is desired; and
only decoding an encoded video stream of a desired video data input indicated by the control signal.

26. The video decoding method of claim 25, wherein an encoded video stream of a first video data input is decoded according to a first video standard, and an encoded video stream of a second video data input is decoded according to a second video standard different from the first video standard.

27. A video encoder, comprising:
a receiving unit, arranged for receiving a plurality of video data inputs corresponding to a plurality of video display formats, respectively, wherein the video display formats include a first three-dimensional (3D) anaglyph video;
a processing unit, arranged for generating a combined video data by combining video contents derived from the video data inputs; and
an encoding unit, arranged for generating an encoded video data by encoding the combined video data.

28. The video encoder of claim 27, wherein the video display formats further include a two-dimensional (2D) video.

29. The video encoder of claim 27, wherein the video display formats further include a second 3D anaglyph video.

30. The video encoder of claim 29, wherein the first 3D anaglyph video and the second 3D anaglyph video utilize different complementary color pairs, respectively.

31. The video encoder of claim 29, wherein the first 3D anaglyph video and the second 3D anaglyph video utilizes a same complementary color pair, and the first 3D anaglyph video and the second 3D anaglyph video have different disparity settings for a same video content, respectively.

32. A video decoder, comprising:
a receiving unit, arranged for receiving an encoded video data having encoded video contents of a plurality of video data inputs combined therein, wherein the video data inputs correspond to a plurality of video display formats, respectively, and the video display formats include a first three-dimensional (3D) anaglyph video; and
a decoding unit, arranged for generating a decoded video data by decoding the encoded video data.

33. The video decoder of claim 32, wherein the video display formats further include a two-dimensional (2D) video.

34. The video decoder of claim 32, wherein the video display formats further include a second 3D anaglyph video.

35. The video decoder of claim 34, wherein the first 3D anaglyph video and the second 3D anaglyph video utilize different complementary color pairs, respectively.

36. The video decoder of claim 34, wherein the first 3D anaglyph video and the second 3D anaglyph video utilizes a same complementary color pair, and the first 3D anaglyph video and the second 3D anaglyph video have different disparity settings for a same video content, respectively.
